(19) United States
(12) Patent Application Publication
(10) Pub. No.: US 2004/0025541 A1
(43) Pub. Date: Feb. 12, 2004

(54) Method and apparatus of making optical fiber

(76) Inventors: Toru Yamada, Kanagawa (JP); Masaharu Oe, Kanagawa (JP)

Correspondence Address: MCDERMOTT, WILL & EMERY, 600 13th Street, N.W., Washington, DC, 20005-3096, US

(21) Appl. No.: 10/439,296

(22) Filed: May 16, 2003

(30) Foreign Application Priority Data
May 16, 2002 (JP) P2002-141870

(51) Int. Cl. C03B 37/07

(52) U.S. Cl. 65/382; 65/377; 65/381; 65/484; 65/486; 65/491

(57) ABSTRACT

In method of making an optical fiber and an apparatus, an optical fiber coated with UV curable resin is drawn at a drawing speed of 1000 m/min or more so that the optical fiber 5 has predetermined coating diameter from 235 μm to 265 μm. A transit time from an exit of a UV curing furnace to an entrance portion of a capstan for pulling the optical fiber downstream is set to be 0.5 seconds or more.

### BACKGROUND OF THE INVENTION

1. Field of the Invention

The present invention relates to a method and apparatus for making an optical fiber in which the optical fiber is drawn at high speed without deforming of the optical fiber.

2. Description of the Related Art

Generally, an optical fiber has a resin coating applied around its circumference to protect the optical fiber. The resin cladding is made of a thermosetting resin such as silicon or UV curable resin.

In the case where the thermosetting resin is used for the resin coating of the optical fiber, it is common that a forced cooling device is provided between a heat curing furnace and a capstan for taking up the optical fiber since the optical fiber drawn from the heat curing furnace has the high temperature.

On the other hand, in the case where the UV curable resin is used for the resin coating of the optical fiber, it is common practice that the optical fiber is naturally cooled in a predetermined length of pass line from an exit of the UV curing furnace to an entrance portion of a capstan, since the optical fiber does not have too high temperature when the optical fiber is pulled from the UV curing furnace. Particularly, in the case of manufacturing the ordinary optical fiber having an outer diameter of about 250 μm after having the resin coating applied, the optical fiber can be sufficiently cooled by natural air-cooling because heat capacity of the resin coated potion of the optical fiber is small.

Referring to FIG. 5, the optical fiber drawing method and apparatus in the related art will be described below. FIG. 5 is a schematic view of a optical fiber drawing apparatus 101 for coating the optical fiber with the UV curable resin.

As shown in FIG. 5, a heating furnace 104 is disposed around a lower end portion 102b of a optical fiber preform 102, in which the optical fiber preform 102 is drawn by melting the lower end portion 102b of the optical fiber preform 102 to produce an optical fiber 105 with smaller diameter.

This optical fiber 105 is fed to a coating device 106. The optical fiber is coated around its circumference with the UV curable resin to be cured by irradiating with ultraviolet ray.

The optical fiber 105, which is coated around its circumference with UV curable resin by the coating device 106, is inserted through a UV curing furnace 107. Then, the coated optical fiber is irradiated with ultraviolet ray, so that the portion of the optical fiber irradiated with the ultraviolet ray gradually reacts to be cured. When the optical fiber 105 is drawn from the UV curing furnace 107, the optical fiber 105 is turned to a different direction by a guide roller 108. Then, the optical fiber 105 is pulled by a capstan 109. The optical fiber 105 is take-up by a take-up bobbin 110.

The capstan 109 includes a capstan wheel 109A and a capstan belt (rubber belt) 109B pressed against the capstan wheel 109A. The optical fiber 105 is pulled in a direction toward the take-up bobbin 110 by driving the capstan wheel 109A or the capstan belt 109B in a state where the optical fiber 105 is held between the capstan wheel 109A and the capstan belt 109B.

Recently, a drawing speed of the optical fiber tends to be increasingly higher to enhance the manufacturing efficiency, and it is demanded to manufacture a large amount of optical fibers in shorter time.

When the drawing speed is increased, the optical fiber 105 is pulled while the optical fiber is held by side face of the capstan 109. However, if the optical fiber is held by the capstan 109 before the UV curable resin is sufficiently cured, irregularities of the rubber of the capstan belt 109B are transferred to the coated optical fiber so that the coated optical fiber is deformed. This deformation is caused to a transmission characteristic failure in the product.

Therefore, if the UV curable resin is employed for the resin coating of the optical fiber, it is believed that the optical fiber can be held by the capstan 109 after the UV curable resin is sufficiently cured owing to small heat capacity, and the optical fiber is not deformed.

However, when a drawing apparatus is employed in a high speed, the optical fiber is deformed in case where the UV curable resin is employed of the resin coating of the optical fiber.

Therefore, the present inventor made an experiment for cooling the clad portion with a cooling device attached in a pass line from the exit of the UV curing furnace to the entrance portion of the capstan. However, it is found that the optical fiber is deformed.

At this time, the temperature of the resin-coated portion of the optical fiber in the pass line from the exit of the UV curing furnace to the entrance portion of the capstan was measured, and the temperature is about 60° C. to 70° C. The optical fiber is sufficiently cooled at this temperature.

Moreover, the present inventor made another experiment. A period of time from the time when the optical fiber was irradiated with ultraviolet ray till the time when the optical fiber entered the capstan was measured by changing the length of pass line from the exit of the UV curing furnace to the entrance portion of capstan but not decreasing the drawing speed. It is found that if the period of time was a predetermined time or more, the optical fiber is not deformed.

Hence, it is esteemed that the deformation of the optical fiber was caused because the reaction time for photochemical polymerization reaction when the UV curable resin was cured could not be sufficiently secured.

### SUMMARY OF THE INVENTION

It is an object of the invention to provide an optical fiber drawing method and apparatus that can draw the optical fiber at high speed without deforming by sufficiently securing a time for curing the UV curable resin.

According to a first aspect of the present invention, there is provided with a method of making an optical fiber, including the steps of:

setting or controlling a length of a pass line between an exit of UV curing furnace and an entrance portion of a capstan for pulling the optical fiber with a coating of UV cured resin;

drawing the optical fiber at a drawing speed of 1000 m/min or more on a condition that a transit time from the exit of UV curing furnace to the entrance portion of the capstan for pulling the optical fiber is set to be 0.5 seconds or more;

coating the optical fiber with a UV curable resin to have a predetermined coating diameter from 235 μm to 265 μm; and

curing the UV curable resin in the UV curing furnace.

In the present invention, a drawing speed is defined by an actual speed in a steady state, when the optical fiber is drawn.

Since the transit time from the exit of the UV curing furnace to the entrance portion of the capstan is set to be 0.5 seconds or more, the reaction time for curing the curable resin can be sufficiently secured, whereby the optical fiber can be drawn at high speed without risk of deformation by the capstan.

According to a second aspect of the invention, there is provided with the method of making the optical fiber wherein

the setting length of the pass line is determined based on a result of arithmetical operation by using a data of an actual drawing speed and a predetermined reaction time for curing the UV curable resin, and

the transit time is longer than the predetermined reaction time.

Since the distance is set up on the basis of the result of arithmetical operation by using the drawing speed and the reaction predetermined time, the transit time from the exit of the UV curing furnace to the entrance portion of the capstan can be made a reaction time or more for curing the UV curable resin.

According to a third aspect of the invention, there is provided with an apparatus of making an optical fiber, including:

a coating device for coating the optical fiber with UV curable resin;

a UV curing furnace for curing the UV curable resin;

a capstan for pulling the optical fiber with a coating of cured UV curable resin;

an arithmetical operation device for calculating a setting length of a pass line between an exit of the UV curing furnace and an entrance portion of the capstan based on a result of an arithmetical operation by using a data of an actual drawing speed and a predetermined reaction time for curing the UV curable resin; and

a control device for controlling a pass line length to be equal to the setting length of the pass line calculated by the arithmetical operation device, wherein

a transit time from the exit of the UV curing furnace to the entranced portion of the capstan is longer than the predetermined reaction time.

With the above constitution, the transit time from the exit of the UV curing furnace to the entrance portion of the capstan can be controlled to be the predetermined reaction time or more for curing the resin coated potion of the optical fiber.

According to a fourth aspect of the invention, there is provided with the apparatus of making the optical fiber, wherein

the transit time is set to be 0.5 seconds or more,

the drawing speed is 1000 m/min or more, and

a coating diameter of the optical fiber is from 235 μm to 265 μm after coating the optical fiber with UV curable resin.

With the above constitution, because the transit time from the exit of the UV curing furnace to the entrance portion of the capstan is set to be 0.5 seconds or more, and the drawing speed is set to be 1000 m/min or more, the optical fiber has predetermined coating diameter from 235 μm to 265 μm.

According to a fifth aspect of the invention, there is provided with the apparatus for making the optical fiber, including:

the control device comprises a guide roller device and a pass line length controller,

the guide roller device includes a first guide roller and a second guide roller,

at least one of the first and second guide rollers is movable to change a distance between the first and second guide rollers, and

the pass line length controller controls a pass line length by changing the distance.

Therefore, the transit time can be made a reaction time or more for curing the resin coated potion of the optical fiber, whereby the optical fiber can be drawn at higher speed without risk of deformation by the capstan.

### BRIEF DESCRIPTION OF THE DRAWINGS

FIG. 1 is a schematic diagram showing an optical fiber drawing apparatus according to an embodiment of the present invention;

FIG. 2 is a schematic perspective view showing a guide roller moving mechanism;

FIG. 3 is a schematic cross-sectional view showing a structure of an optical fiber;

FIG. 4 is a graph representing the relationship between the number of abnormal points and the transit time when drawing the optical fiber at a drawing speed from 1000 m/min to 1500 m/min with an optical fiber drawing method according to an embodiment of the invention;

FIG. 5 is a schematic view of the optical fiber drawing apparatus in the related art; and

FIG. 6 is a graph showing relationship between a curing rate of each of UV cured resins and a transit time of three optical fibers (A, B, C) according to an embodiment of the invention.

### DESCRIPTION OF THE PREFERRED EMBODIMENTS

The preferred embodiments of an optical fiber drawing method and apparatus according to the present invention will be described below with reference to the accompanying drawings.

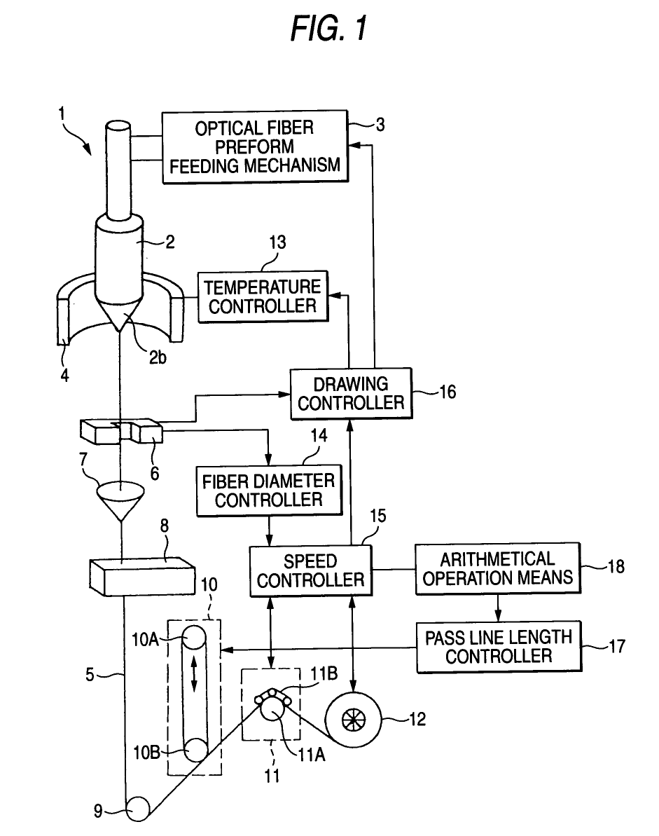

FIG. 1 is a schematic diagram showing an optical fiber drawing apparatus for coating the optical fiber with UV curable resin. In FIG. 1, the optical fiber drawing apparatus 1 has a optical fiber preform 2 like a glass rod having a certain distribution of refractive index formed beforehand for a core and a clad. The optical fiber preform 2 is produced by dehydrating and heating the deposit of glass particles like a rod, and vitrifying the deposited glass rod. The optical fiber preform 2 produced in this manner is supported by an optical fiber preform feeding mechanism 3 disposed on the top of a manufacturing apparatus. The optical fiber preform feeding mechanism 3 grasps an upper portion of the optical fiber preform 2 to be movable vertically.

A heating furnace 4 is disposed around a lower end portion 2b of the optical fiber preform 2, whereby the optical fiber preform 2 is drawn by melting the lower end portion 2b of the optical fiber preform 2 to produce an optical fiber 5 with smaller diameter. The optical fiber 5 has its diameter measured by a fiber diameter measuring instrument 6, and is fed to a coating device 7. The coating device 7 coats the outer circumference of the optical fiber 5 with UV curable resin to be cured by irradiation of ultraviolet ray.

The optical fiber 5 that UV curable resin is applied around the outer circumference thereof by the coating device 7 is inserted through a UV curing furnace 8 to be irradiated with ultraviolet ray, so that the coated portion of the optical fiber, which is irradiated with ultraviolet ray, gradually reacts to be cured. The optical fiber 5 exiting from the UV curing furnace 8 is turned to a different direction by a guide roller 9. The optical fiber is pulled via guide rollers 10A and 10B for a guide roller moving mechanism 10by a capstan 11 and wound around a take-up bobbin 12. In the guide roller moving mechanism 10, a plurality of guide rollers may be used as the guide roller 10A, 10B.

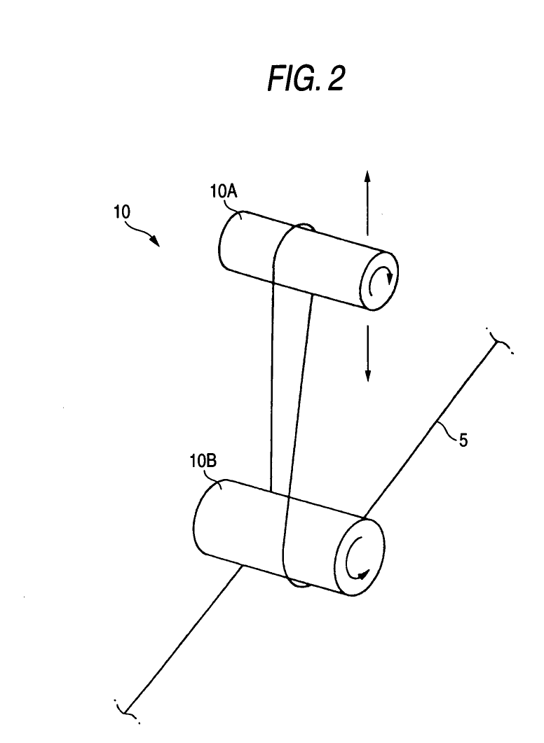

The guide roller moving mechanism 10 includes the guide rollers 10A and 10B. The guide roller moving mechanism 10 can change the position of a guide roller 10A, as shown in FIG. 2. The distance between the guide rollers 10A and 10B can be adjusted by changing the position of the guide roller 10A. In this manner, a pass line length from the exit of the UV curing furnace 8 to the entrance portion of the capstan 11 can be changed by changing the distance between the guide rollers 11A and 10B.

In case that a plurality of the UV curing furnaces 8 are provided, the pass line length is defined by a length of a pass line between an exit of the last UV curing furnace and the entrance portion of the capstan 11.

The capstan 11 includes a capstan wheel 11A and a capstan belt 11B pressed against the capstan wheel 11A, and the optical fiber 5 is pulled in a direction toward the take-up bobbin 12 by driving the capstan wheel 11A or the capstan belt 11B in a state where the optical fiber 5 is held between the capstan wheel 11A and the capstan belt 11B.

The optical fiber drawing apparatus 1 comprises a temperature controller 13 for controlling the temperature of the heating furnace 4, a fiber diameter controller 14 for controlling the outer diameter of the optical fiber 5, a speed controller for controlling the speeds of the capstan 11 and the take-up bobbin 12, a drawing controller 16 for controlling the drawing speed of the optical fiber 10, and a pass line length controller 17 for controlling the distance between the guide rollers 10A and 10B of the guide roller moving mechanism 10.

The optical fiber 5 exiting from the heating furnace 4 has its diameter measured by the fiber diameter measuring instrument 6, its measurement result being input into the fiber diameter controller 14.

Subsequently, the fiber diameter controller 14 forwards the information regarding the outer diameter of the optical fiber 5 into the speed controller 15, which controls the drawing speed so that the outer diameter of the optical fiber 5 may be a desired one. This drawing speed information is passed to the drawing controller 16, which compares the set drawing speed and the drawing speed at present, and a optical fiber preform feeding rate is adjusted by the optical fiber preform feeding mechanism 3 to adjust a difference between the set drawing speed and the drawing speed.

The guide rollers 9, 10A and 10B do not apply pressure to the optical fiber 5 from the lateral sides of the guide rollers to hold the optical fiber 5 between them. The guide rollers do not have effect on the optical fiber 5 to deform the resin clad portion 5B. The optical fiber 5 pulled by the capstan 11 is wound around the take-up bobbin 12.

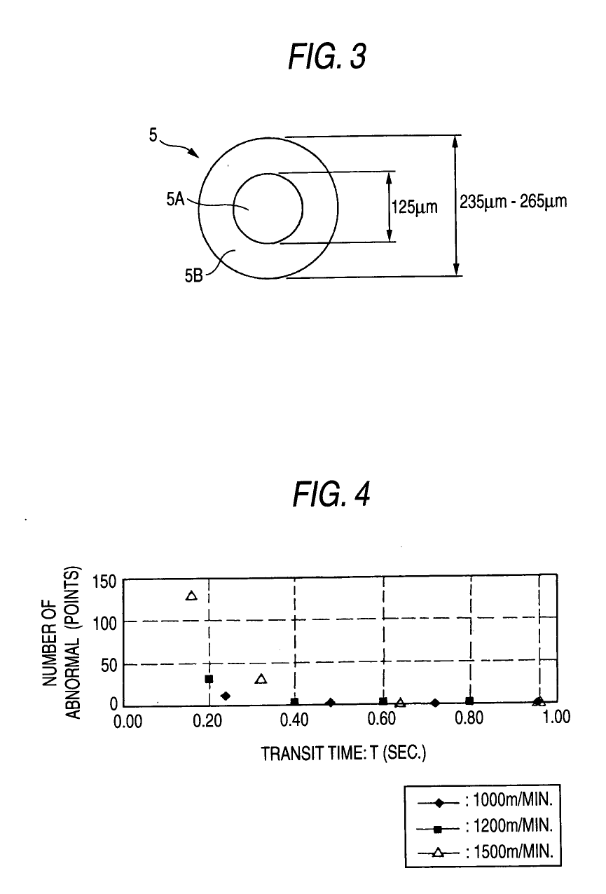

The optical fiber 5 drawn by this optical fiber drawing apparatus 1 includes a glass portion 5A and a resin coated portion 5B as shown in FIG. 3. The optical fiber 5 has predetermined coating diameter from 235 μm to 265 μm. The glass portion of the optical fiber 5 has diameter of 125 μm.

In the optical fiber drawing apparatus 1 of this embodiment, arithmetical operation device 18 calculates the length of pass line required to secure the reaction time for curing the UV curable resin by arithmetical operation, which uses the predetermined reaction time and an actual drawing speed in the pass line, when forming the UV curable resin coated optical fiber 5 having the coating diameter from 235 μm to 265 μm.

The information regarding the calculated required length of pass line is passed to the pass line length controller 17, which controls the guide roller moving mechanism 10 to change the pass line length from the exit of the UV curing furnace 8 to the entrance portion of the capstan 11.

In this manner, the transit time T taken for the optical fiber 5 to transit from the exit of the UV curing furnace 8 to the entrance portion of the capstan 11 is secured.

The transit time T is taken to secure the reaction time for curing the UV curable resin, and set at 0.5 seconds or more when drawing the optical fiber at a drawing speed of 1000 m/min or greater.

Thereby, the time of photochemical polymerization to cure the UV curable resin can be sufficiently secured. Therefore, there is no risk that the optical fiber is deformed by the capstan 11 when being drawn at high speed.

The present inventor made an experiment of drawing the optical fiber at a drawing speed of 1000 m/min to 1500 m/min, and measuring the number of appearance abnormality occurrences (number of abnormal points) in the resin coated portion of the optical fiber by adjusting the guide roller moving mechanism 10 under the control of the pass line length controller 17 to change the pass line length and set up a transit time, whereby the results of Table 2 were obtained. The number of abnormal points is counted for irregular points that can be discriminated in a unit of 5 mm length for the optical fiber.

The reference values at the slower drawing speed of 600 m/min to 800 m/min are listed in Table 1.

TABLE 1

| Pass line length | Drawing speed | Transit time | Abnormal |
|---|---|---|---|
| [m] | [m/min] | [second] | points |
| 4 | 600 | 0.40 | 0 |
| 8 | 600 | 0.80 | 0 |
| 16 | 800 | 1.20 | 0 |
| 24 | 800 | 1.80 | 0 |
| 4 | 1000 | 0.24 | 10 |
| 8 | 1000 | 0.48 | 1 |
| 12 | 1000 | 0.72 | 0 |
| 16 | 1000 | 0.96 | 0 |
| 4 | 1200 | 0.20 | 32 |
| 8 | 1200 | 0.40 | 3 |
| 12 | 1200 | 0.60 | 0 |
| 16 | 1200 | 0.80 | 0 |
| 4 | 1500 | 0.16 | 128 |
| 8 | 1500 | 0.32 | 32 |
| 16 | 1500 | 0.64 | 0 |
| 24 | 1500 | 0.96 | 0 |

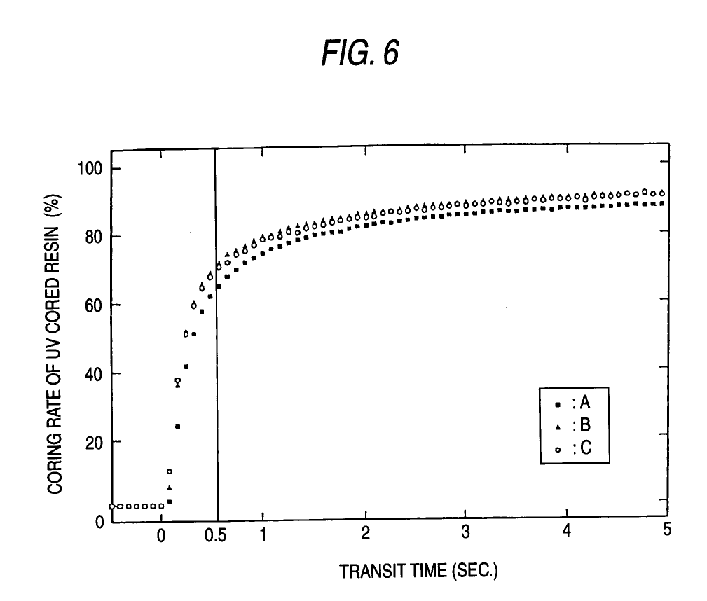

Further, FIG. 4 shows a relationship between the number of abnormal points and the transit time from the results of Table 2. FIG. 6 shows a relationship between a curing rate of each of UV cured resins and the transit time of each of three optical fibers (A, B, C). Each of the UV curable resins applied to each of three optical fibers (A, B, C) is a different type of resin. The curing rate of UV cured resin is obtained based on the amount of double bonding of CH₂═CH existing in the UV cured resin after UV curing of the optical fiber. As shown in FIG. 4, it is found that if the transit time T is set at 0.5 seconds or more, the number of appearance abnormality occurrences (number of abnormal points) in the resin coated portions of the optical fiber becomes zero. Further, as shown FIG. 6, it is found that the transit time T set at 0.5 seconds or more, each optical fiber can be practically used. Thereby, there is no risk that the optical fiber is deformed by the capstan 11 in a region where the optical fiber is drawn at a high drawing speed of 1000 m/min or more.

As described above in detail, with the invention, the transit time taken for the optical fiber to transit from the exit of the UV curing furnace to the entrance portion of the capstan is set to be 0.5 seconds or more, whereby the reaction time for curing the UV curable resin can be sufficiently secured. Accordingly, the optical fiber can be drawn at high speed without risk of deformation by the capstan, resulting in enhanced manufacturing efficiency.

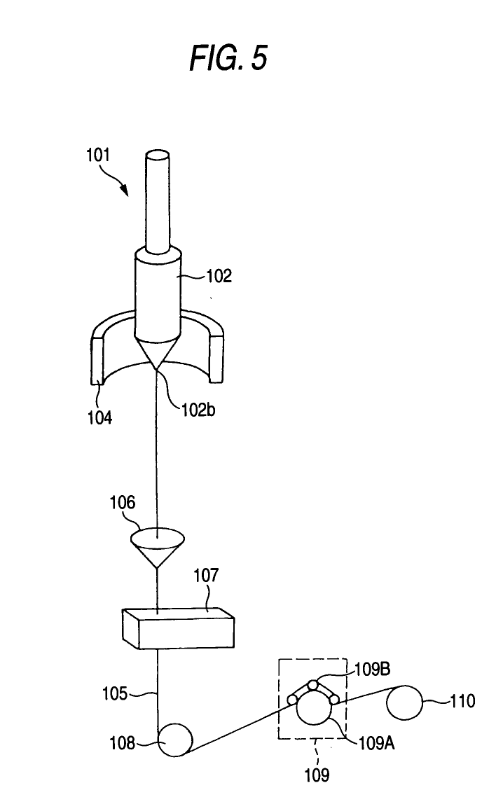

As herein described, the apparatus employs the capstan, but the apparatus using a tension helper (without 109B in FIG. 5) can have the same effects because the irregularities on the surface are transferred according to the same principle.

What is claimed is:

1. A method of making an optical fiber, comprising the steps of:
setting or controlling a length of a pass line between an exit of UV curing furnace and an entrance portion of a capstan for pulling said optical fiber with a coating of UV cured resin;
drawing said optical fiber at a drawing speed of 1000 m/min or more on a condition that a transit time from said exit of UV curing furnace to said entrance portion of said capstan for pulling said optical fiber is set to be 0.5 seconds or more;
coating said optical fiber with a UV curable resin to have a predetermined coating diameter from 2351 μm to 265 μm; and
curing said UV curable resin in said UV curing furnace.

2. The method of making an optical fiber according to claim 1,
wherein
said setting length of said pass line is determined based on a result of arithmetical operation by using a data of an actual drawing speed and a predetermined reaction time for curing said UV curable resin, and
said transit time is longer than said predetermined reaction time.

3. An apparatus for making an optical fiber, comprising:
a coating device for coating said optical fiber with UV curable resin;
a UV curing furnace for curing said UV curable resin;
a capstan for pulling said optical fiber with a coating of cured UV curable resin;
an arithmetical operation device for calculating a setting length of a pass line between an exit of said UV curing furnace and an entrance portion of said capstan based on a result of an arithmetical operation by using a data of an actual drawing speed and a predetermined reaction time for curing said UV curable resin; and
a control device for controlling a pass line length to be equal to said setting length of said pass line calculated by said arithmetical operation device,
wherein
a transit time from said exit of said UV curing furnace to said entranced portion of said capstan is longer than said predetermined reaction time.

4. The apparatus for making of the optical fiber according to claim 3,
wherein
said transit time is set to be 0.5 seconds or more,
said drawing speed is 1000 m/min or more, and
a coating diameter of said optical fiber is from 235 μm to 265 μm after coating said optical fiber with UV curable resin.

5. The apparatus for making the optical fiber according to claim 3,
wherein
said control device comprises a guide roller device and a pass line length controller,
said guide roller device includes a first guide roller and a second guide roller,
at least one of said first and second guide rollers is movable to change a distance between said first and second guide rollers, and
said pass line length controller controls a pass line length by changing said distance.
